(19) United States
(12) Patent Application Publication
(10) Pub. No.: US 2013/0202489 A1
(43) Pub. Date: Aug. 8, 2013

(54) GAS SENSOR WITH A HIGHLY POROUS STRUCTURE CONSTRUCTED OF CATALYST-CAPPED METAL-OXIDE NANOCLUSTERS

(71) Applicants: Chung Wo ONG, Hong Kong (HK); Meng ZHAO, Hong Kong (HK); Jian Xing HUANG, Hong Kong (HK); Man Hon WONG, Hong Kong (HK)

(72) Inventors: Chung Wo ONG, Hong Kong (HK); Meng ZHAO, Hong Kong (HK); Jian Xing HUANG, Hong Kong (HK); Man Hon WONG, Hong Kong (HK)

(73) Assignee: The Hong Kong Polytechnic University, Hung Hom (HK)

(21) Appl. No.: 13/365,277

(22) Filed: Feb. 3, 2012

(51) Int. Cl. G01N 21/62; G01N 31/00; B82Y 15/00

(52) U.S. Cl. 422/83; 977/811; 977/902

(57) ABSTRACT

A gas sensor includes a plurality of loosely connected metal oxide nanoclusters configured to provide a porous structure, the metal oxide nanoclusters having an average characteristic length of 1 nm to 20 nm, and a coating made with catalytic material is deposited on an outer layer of the metal oxide nanoclusters.

### BACKGROUND OF THE INVENTION

1. Field of the Invention

The present invention is related to a gas sensor, and more particularly, to a catalyzed metal-oxide nanoclusters gas sensor having a highly porous structure.

2. Description of the Related Art

General Description of Performance Indexes of a Gas Sensor

As gas sensing technology advances, it is recognized that a set of parameters is required to reflect the performance of a gas sensor in many aspects. The list depends on individual applications. Attempts in further improvement of the indexes indicate the directions of research and development work. The major parameters can be summarized as follows:

(a) Lowest detection limit (LDL) is the lowest detectable gas concentration. It is preferred to be as small as possible, especially in the application of detecting leakage of a hazardous gas.

(b) Highest detection limit (HDL) is the highest detected gas concentration above which the sensing response starts to be saturated. Achievement of a higher HDL facilitates broadening the dynamic range of the sensor.

(c) Sensitivity (S) of a gas sensor can be defined in different ways depending on their operation principles and uses. It is generally expressed in terms of the change of a physical property of the sensor, e.g., resistance or optical transmittance, depending of the concentration of the detected gas. For a sensor showing a rise of resistance from a base value, Rₒ, to the saturated one, R_{H2}, under the presence of the detected gas, S can be defined as (R_{H2}−Rₒ)/Rₒ. If the resistance of the sensor drops, S can be defined as (Rₒ−R_{H2})/R_{H2}. In this case, if the gas concentration is high enough for Rₒ>>R_{H2}, S can be approximated as Rₒ/R_{H2}.

(d) Normalized sensitivity (NS) can be defined as S divided by the concentration of the detected gas. The use of NS is more convenient than the use of S for comparing the performance between different sensors, because it is the sensor's response normalized to unit concentration of the detected gas. It is required to be as large as possible.

(e) Response time (t_{R}), is defined as the time for S to reach 90% of the saturated value in a test. It is required to be as short as possible.

(f) Durability can be defined in two different ways. (i) In static mode of operation, it is the duration in which the output of a sensor at a specific detected gas concentration remains stable. (ii) In cyclic mode of operation where the sensor is alternatively exposed to the detected gas and background atmosphere repeatedly, durability is expressed in terms of the number of cycles in which the range of the sensor's response remains stable. Note that there are still no common standards for assessing the durability of a gas sensor in these modes, such that data reported by different labs are not easily compared. In addition, data of cyclic stability of gas sensors are less reported. Even in some reports showing results of cyclic tests, the numbers of switching cycles carried out in the experiments are generally too little for the cyclic lifetime of the samples to be fairly assessed. Therefore, efforts are needed for making new sensors of improved static and cyclic durability, and are also needed for establishing commonly accepted measurement standards for assessing gas sensors' performance in this aspect.

(g) Selectivity reflects the ability of a gas sensor to resist interference from other gases, which are mostly combustion gases, reducing gases and volatile organic compounds (VOCs) etc.

(h) Atmospheric pressure dependence of the output of a sensor is required to as mild as possible for it to be usable in a range of elevation of substantial change in ambient pressure. One important example is a H₂ sensor used in a H₂-driven vehicle, which vertical scope of operation may reach a height of 9000 m from sea level, versus a pressure change from 101 to 30.7 kPa.

(i) Operation temperature has two definitions in this document. It can be defined as the temperature of the sensing element, Tₛₑₙₛₒᵣ, during operation. Some sensors require to operate at an elevated Tₛₑₙₛₒᵣ. They usually needs a heater, flame arrester and related controlling circuits, and hence are more costly and bulky. The output may also be unstable due to annealing effect and/or thermal drift. Operation temperature can also be defined as the environment temperature, Tₑₙᵥᵢᵣₒₙ, which may cover a range from a few negative tens of ° C. (coldest places on earth) to over 100° C. (beside to an engine). Efforts are needed for making new sensors of lower Tₛₑₙₛₒᵣ close to the ambient temperature for avoiding the abovementioned drawbacks, but are also needed for reducing Tₑₙᵥᵢᵣₒₙ dependence of output.

(j) Relative humidity (RH) dependence of a gas sensor is required to be as weak as possible for avoiding the influence of moisture on the output and degradation of the sensor's performance.

(k) Batch-to-batch reproducibility indicates how stable the performance of products fabricated in different batches with the same process can be maintained. New process of improved batch-to-batch reproducibility helps promote the yield and lower the cost of production.

(l) Miniaturizability of a gas sensor is required for mass production, lowering of power consumption and integrating the device to a battery-powered portable appliance.

(m) Power consumption of new gas sensors is required to be as low as possible.

(n) Price of a gas sensor is required to be as low as possible.

H₂ is a major constituent in many gaseous fuels, and is broadly used in industries and plays an important role in green energy technology. Being highly explosive, reliable H₂ sensors are needed for monitoring H₂ leakage to avoid hazards.

Some general remarks are highlighted as follows. Firstly, LDL of various types of conventional H₂ sensor products varies from 10 parts per million (ppm) to 5%. Secondly, HDL is usually represented by the maximum value of H₂ concentration [H₂] used in a test. It usually falls in the range of 0.1 to 4%. Thirdly, durability of various sensor types is commonly claimed to be 2-10 years. However, these data are not quite useful, because they may not be derived according to a common standard. Data of cyclic lifetime are rarely found in literatures.

An electrochemical (EC) type H₂ sensor contains a working and counter electrodes immersed in an electrolyte. Hydrogen atoms are produced by dissociating H₂ molecules from the environment at the electrodes, and then enter the electrolyte to generate an amperometric or potentiometric signal. For such a sensor, the output is insensitive to the variations of atmospheric pressure, Tₑₙᵥᵢᵣₒₙ and RH. It can work at a Tₛₑₙₛₒᵣ close to the ambient temperature, and does not need a heater and related temperature controlling components. However, as disclosed in Korotcenkov et al., “Review of Electrochemical Hydrogen Sensors”, Chem Rev 109, it has a low NS˜0.002/ppm (at 1.15% H₂) and is readily affected by reducing gases. Batch-to-batch reproducibility of products is not satisfactory. Miniaturization is not readily achieved and the production cost is relatively high.

A metal-oxide (MOₓ) type H₂ sensor adsorbs O₂ molecules on the oxide surface. They extract free electrons from the metal oxide and become ions. Meanwhile, a depletion layer is formed at the surface of the oxide. The sensor shows a high resistance at this state. When H₂ molecules appear to reach the oxide surface, they react with some surface sorbed oxygen ions and remove them from the oxide surface. Meanwhile, free electrons are released and return to the oxide, such that the depletion region becomes thinner. The resistance of the sensor drops with a magnitude depending on [H₂] in the detected region. According to Shimizu et al., “Effects of gas diffusivity and reactivity on sensing properties of thick film SnO2-based sensors”, a sensor of this type has a high NS˜0.15/ppm (at 2% H₂). However, the output is affected by the presence of reducing gases, and depends prominently on atmospheric pressure, Tₑₙᵥᵢᵣₒₙ and RH. Furthermore, it needs to work at an elevated Tₛₑₙₛₒᵣ, leading to many disadvantages mentioned before, such as thermal instability of output, being bulky, difficulty in miniaturization, high power consumption ˜500 mW and high production cost. Thick film processes are usually employed in fabrication, but batch-to-batch reproducibility is usually not ensured.

A catalytic combustion (CC) type H₂ sensor is made of a surface catalyzed material, which requires to work at an elevated Tₛₑₙₛₒᵣ. If H₂ molecules appear to reach its surface, they are oxidized to cause a rise of the temperature of the sensor. The temperature change is detected by a platinum (Pt) thermometer adhered to the sensor. A sensor of this type is insensitive to atmospheric pressure, Tₑₙᵥᵢᵣₒₙ and RH. The production process has satisfactory reproducibility. However, its NS is low, i.e. <5.3×10⁻⁴/ppm (at 1% H₂) and Tₛₑₙₛₒᵣ is high. Its output is easily affected by the presence of other combustion gases. Also, it is difficult to be miniaturized and its power consumption is high, which is generally greater than 500 mW. The production cost of a CC type H₂ sensor is relatively high.

A thermal conductivity (TC) type H₂ sensor monitors the thermal conductivity of a gas sample. H₂ has the highest thermal conductivity compared to those of all other gases. Its presence in a gas sample can cause a notable change in the overall thermal conduction of the gas sample, which is a measure of [H₂] in the environment. A sensor of this type is insensitive to interferants, atmospheric pressure, and RH. It also has a low Tₛₑₙₛₒᵣ. The batch-to-batch reproducible is fairly satisfactory. However, the sensor has a low NS˜2.5×10⁻⁶/ppm and strong dependence on Tₑₙᵥᵢᵣₒₙ. Miniaturization of a TC type H₂ sensor is difficult. Power consumption is relatively high (>500 mW), and production cost is high.

A palladium (Pd)-based H₂ sensor contains a Pd-based sensing element. The substance is switched from a conducting metallic state to a semiconducting hydride state during hydrogenation, accompanied with a raise in resistance. The process is revised during dehydrogenation. The change of resistance reflects the level of [H₂] in an environment. It has the advantages as those of a TC-type H₂ sensor. Furthermore, it can be made in the form of a thin film to facilitate miniaturization. However, a sensor of this type has low NS 7.6×10⁻⁷/ppm (measured at 2% H₂); strong Tₑₙᵥᵢᵣₒₙ dependence; high power consumption and high production cost.

A nano-Pd-based H₂ sensor has a Pd or Pd-based material made to contain some cracks, or to be porous with the presence of pores. The cracks are opened at H₂-free condition, and the resistance of the sensor is higher than that of the one without cracks. When H₂ appears to react with Pd, the material experiences a remarkable volume expansion to force the cracks to close. A percolation-type reduction in sensor's resistance occurs. The resistance change is related to the level of [H₂]. According to Xu et al., “Self-assembled monolayer-enhanced hydrogen sensing with ultrathin palladium films”, a sensor of this type shows a very short t_{R}≈0.068 s, quite mild Tₛₑₙₛₒᵣ and Tₑₙᵥᵢᵣₒₙ dependences. Its output is also insensitive to many interferants. Miniaturization is feasible by making the sensor in the form of a thin film. However, the value of NS˜3×10⁻⁴/ppm is low (measured at 1% H₂). Moreover, the sensor must be made such that the percolation condition is satisfied at a specific [H₂] to be detected in an application, but the microstructure of the film is not readily controlled and even repeatable from batch to batch.

In view of the deficiencies of the above conventional hydrogen sensors, there is a call for more advanced hydrogen sensors exhibiting a high sensitivity, fast response rate, better durability and selectivity, milder ambient pressure and RH dependences, lower operation temperature, satisfactory production reproducibility and miniaturizability, lower power consumption, and lower cost of production.

### SUMMARY OF THE INVENTION

According to one aspect, the present invention provides a gas sensor that includes a plurality of loosely connected metal oxide nanoclusters configured to provide a porous structure, with the metal oxide nanoclusters having an average characteristic length of 1 nm to 20 nm, and a catalytic coating deposited on an outer layer of the metal oxide nanoclusters.

Further features and aspects of the present invention will become apparent from the following description of exemplary embodiments with reference to the attached drawings.

### BRIEF DESCRIPTION OF THE DRAWINGS

FIGS. 1(a)-(c) illustrate an exemplary H₂ sensor having a highly porous structure made of MOₓ nanoclusters and a catalytic metal coating on the surface. (a) It is completely depleted in an H-free environment. (b) Tunneling of charge carriers across the contact regions among the outermost nanoclusters. (c) Establishment of a conduction path near the sensor surface.

FIGS. 2(a)-(c) illustrate another exemplary H₂ sensor having a highly porous structure made of MOₓ nanoclusters and catalytic metal atoms deposited on nanoclusters at different depths. (a) It is completely depleted in an H-free environment. (b) Tunneling of charge carries across the contact regions of nanoclusters at all depths. (c) Establishment of conduction paths at all depths.

FIG. 3 illustrates an exemplary schematic diagram of a deposition system combining a Supersonic Cluster Beam Deposition system and a thermal evaporator.

FIG. 4 illustrates a pattern of interdigital electrodes (IDEs) made on a MOₓ nanoclusters H₂ sensor for adjusting the base resistance to fall in a reasonable range.

FIG. 5 illustrates two TEM images of a Pd/SCBD WO₃ nanoclusters H₂ sensor showing the presence of (a) 3˜5 nm WO₃ nanoclusters; and (b) Pd atoms at the top surface of the nanoclusters.

FIGS. 6(a) and (b) are graphs illustrating sensitivity of a Pd/SCBD WO₃ nanoclusters H₂ sensor versus [H₂] measured at Tₛₑₙₛₒᵣ equal to (a) 20° C. and (b) 80° C. respectively.

FIGS. 7(a) and (b) are graphs illustrating t_{R} of a Pd/SCBD WO₃ nanoclusters H₂ sensor versus [H₂] measured at Tₛₑₙₛₒᵣ equal to (a) 20° C. and (b) and 80° C. respectively.

FIGS. 8(a) and (b) are graphs illustrating cyclic resistive response of a Pd/SCBD WO₃ nanoclusters H₂ sensor recorded when exposed to 2% H₂-air mixture and dry air alternatively at Tₛₑₙₛₒᵣ equal to (a) 20° C. and (b) 80° C. respectively.

FIGS. 9(a) and (b) are graphs illustrating atmospheric pressure dependence of resistive response of a Pd/WO₃ SCBD nanoclusters H₂ sensor measured at Tₛₑₙₛₒᵣ equal to (a) 20° C. and (b) 80° C., respectively.

FIG. 10 illustrates the resistance change of a Pd/SCBD ZnO nanoclusters sensor when exposed to 2% H₂-air mixture in accordance with another embodiment of the present invention.

FIG. 11 illustrates the resistance change of a SCBD zinc oxide (ZnO) oxygen sensor when expose to air and nitrogen repeatedly under ultraviolet (UV) irradiation in accordance with another embodiment of the present invention.

FIG. 12 illustrates the sensing properties of a SCBD titanium oxide (TiO₂) thin film to formaldehyde in accordance with another embodiment of the present invention.

### DESCRIPTION OF THE EMBODIMENTS

The accompanying drawings, which are incorporated in and constitute a part of the specification, illustrate embodiments of the invention and, together with the description, serve to explain the principles of the invention.

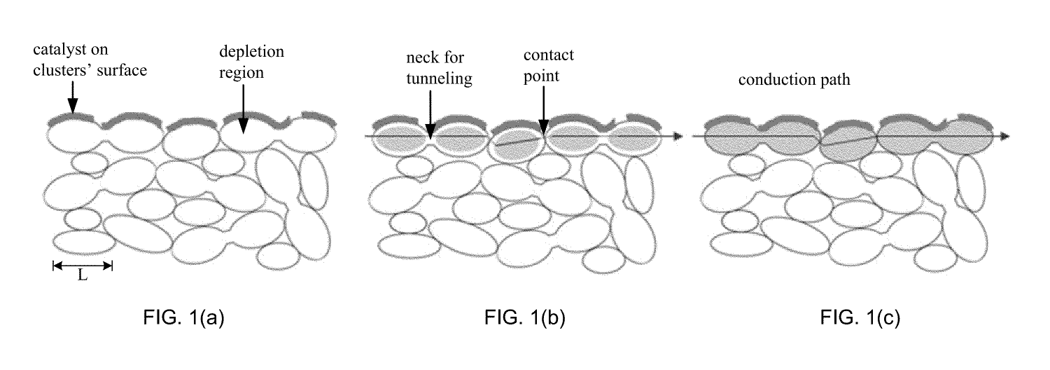

According to one embodiment, the present H₂ sensor is made of metal-oxide (MOₓ) nanoclusters with an average characteristic length (L) close to two times of the maximum achievable thickness of a depletion layer of the material. The nanoclusters are loosely connected together by physical contact or necking as shown in FIG. 1(a). With this configuration, when the sensor is placed in air without the presence of H₂, the nanoclusters are fully depleted, whereas the charge carriers of the oxide nanoclusters are trapped by the oxygen molecules adsorbed on the nanocluster surfaces. At this stage, the resistance of the sensor, called the base resistance, Rₒ, reaches the highest achievable value. When H₂ appears and reacts with the oxide nanoclusters, the resistance of the sensor, denoted as R_{H2}, can drop to vary in a broad dynamic range. As a consequence, a high sensitivity of gas detection and a low LDL are achieved.

Also because the structure has a huge effective solid-gas interfacial area, H₂ and the oxide nanoclusters can react more effectively to enhance the sensitivity of detection. In addition, the MOₓ nanoclusters are in spherical-like geometry. They are packed loosely either by physical contact or necking in between with porosity of the structure not lower than 20%. As a consequence, H₂ molecules can diffuse agilely in the structure to achieve a fast response rate, or equivalently a short response time. If the reaction rate of the sensor operating at a lower Tₛₑₙₛₒᵣ is fast, reaction is fully completed within a short measurement time. This results in a higher apparent sensitivity.

FIG. 1(a) illustrates an exemplary hydrogen sensor with a plurality of MOₓ nanoclusters that are connected loosely in multiple layers to provide a highly porous structure, in which H₂ molecules can diffuse agilely to result in a fast response rate. This allows the sensor to operate at a lower temperature Tₛₑₙₛₒᵣ with a reasonably fast response rate. Effective lowering of Tₛₑₙₛₒᵣ diminishes the drawbacks of a conventional MOₓ-based sensor associated with the need of a high Tₛₑₙₛₒᵣ. According to one embodiment, the nanoclusters have an average characteristic length (L) of 1-20 nm, which are connected to generate a structure of an overall porosity of at least 20%.

Depending on the gas (e.g., hydrogen gas, oxygen gas, etc.) to be detected, a suitable metal oxide can be selected to form the metal oxide nanoclusters for making the sensor. For example, tungsten oxide, tin oxide, titanium oxide, zinc oxide, iron oxide, niobium oxide, vanadium oxide, molybdenum oxide, etc., or combination thereof, which are capable of reacting with a specific target gas, can be used.

A thin coating of catalytic material such as palladium (Pd) or platinum (Pt), capable of causing catalytic dissociation of H₂, is deposited on all or a certain group of nanoclusters. Other catalytic materials known in the field may include silver, gold, rhodium, ruthenium, nickel, iron, cobalt, osmium, their alloys and oxides, etc., or a combination thereof. FIG. 1(a) illustrates an example where the coating is made on the surface of the sensor. Thereby, catalytic dissociation of H₂ is mainly induced on the outermost layer of nanoclusters. In this embodiment, the outermost layer of nanoclusters is responsible for causing a drop in the sensor's resistance when reacting with H₂. With increasing degree of hydrogenation, charge carriers first tunnel through the contact regions among them, as shown in FIG. 1(b), and finally a complete conduction path is established near the surface of the sensor, as shown in FIG. 1(c).

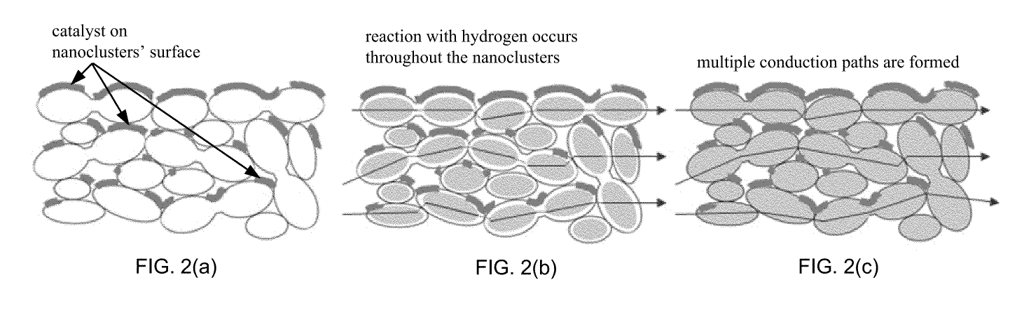

FIG. 2(a) illustrates another embodiment of the present invention in which the catalytic coating is deposited on all nanoclusters located throughout the depth of the sensor. As a consequence, all of the nanoclusters in the sensor can contribute in catalytic dissociation of H₂ and generation of a resistive response. With increasing degree of hydrogenation, tunneling of charge carriers occurs first, as shown in FIG. 2(b), and finally conduction paths at different depths are established, as shown in FIG. 2(c). Compared with the gas sensor of FIG. 1(a), this configuration leads to further enhancement of detection sensitivity.

It is further noted that a depth profile of the catalytic coating intermediately between the above two cases can be realized according to the needs of specific applications. The performance indexes of the existing major H₂ sensor in comparison with the present MOₓ nanocluster sensor made of tungsten oxide (WO₃), as described in one of the worked examples, are summarized in Table 1 below.

TABLE I
Performance indexes of major existing types of
H₂ sensor products and the MOₓ nanoclusters sensor

| | | | | | | Nano-Pd- | | |
|---|---|---|---|---|---|---|---|---|
| | EC-type | MOₓ-type | CC-type | TC-type | Pd-based | based | WO₃ nanoclusters sensor | |
| | sensor | sensor | sensor | sensor | sensor | sensor | At 20° C. | At 80° C. |
| LDL | 100 ppm | 50 ppm | >100 ppm | 1000 ppm | 5000 ppm | 10 ppm | <1.5 ppm | <2.5 ppm |
| | | | | | | | (estimated | (estimated |
| | | | | | | | limit | limit |
| | | | | | | | ≈0.037 ppm) | ≈0.028 ppm) |
| UDL | ≦4% | ≦2% | ≈4% | ≦100% | ≦100% | 1% | >2% | >2% |
| NS (ppm⁻¹) | 0.002/ | 0.15/ppm | <5.3 × | 2.5 × 10⁻⁶/ | 7.6 × 10⁻⁷/ | 3 × 10⁻⁴/ | 0.527 at 2% | 9.4 at 2% H₂ |
| | ppm at | at 2% H₂ | 10⁻⁴/ | ppm at | ppm at | ppm at 1% | H₂ | |
| | 1.15% H₂ | | ppm at | 10% He | 2% H₂ | H₂ | | |
| | | | 1% H₂ | | | | | |
| t_{R} measured at | 30~60 s | 5~20 s | 10~30 s | 10~50 s | <60 s | 0.068 s | 4 s | <1 s |
| 2% H₂ | | | | | | 4 s | | |
| Static lifetime | 2 years | 5 years | 3~5 | 5 years | 5~10 | 2~3 years | >2 years | |
| | | | years | | years | | | |
| Cyclic lifetime | no data | no data | no data | no data | no data | no data | >2400 cycles | |
| Selectivity | affected | affected | affected | good | good | good | good | |
| | by | by | by | | | | | |
| | reducing | reducing | combustion | | | | | |
| | gases | gases | gases | | | | | |
| Atmospheric | mild | strong | weak | weak | no data | no data | no dependence in 30~120 kPa | |
| pressure | (90~110 kPa) | (80~120 kPa) | (80~120 kPa) | (70~130 kPa) | (80~100 kPa) | (80~120 kPa) | | |
| dependence | | | | | | | | |
| Tₛₑₙₛₒᵣ | −20~50° C. | 400~500° C. | 400~500° C. | 100~200° C. | 120° C. | 80° C. | 20~130° C. | |
| | ″ | | | | | | | |
| Tₑₙᵥᵢᵣₒₙ | moderate | −20~80° C. | −20~80° C. | 0~50° C. | −20~50° C. | −20~80° C. | ″ | |
| Tₑₙᵥᵢᵣₒₙ | | strong | weak | strong | strong | moderate | strong | moderate |
| dependence | | | | | | | | |
| RH dependence | weak | strong | nil | weak | nil | no data | strong | nil |
| (observed range) | (15~90%) | (10~95%) | (0~95%) | (0~95%) | (0~95%) | (0~95%) | (0~70%) | (0~95%) |

| Batch-to-batch | poor | poor | good | good | good | poor | good |
|---|---|---|---|---|---|---|---|
| reproducibility | | | | | | | |
| Miniaturizability | difficult | difficult | difficult | difficult | yes | yes | yes |
| Power | <100 mW | >500 mW | | | | | ~1 μW |
| consumption | | | | | | | (from |
| | | | | | | | sensor's |
| | | | | | | | resistance) |
| Unit price | US 1200 | US 300~500 | US 1700 | >US 1000 | >US 2000 | | cheaper than others |

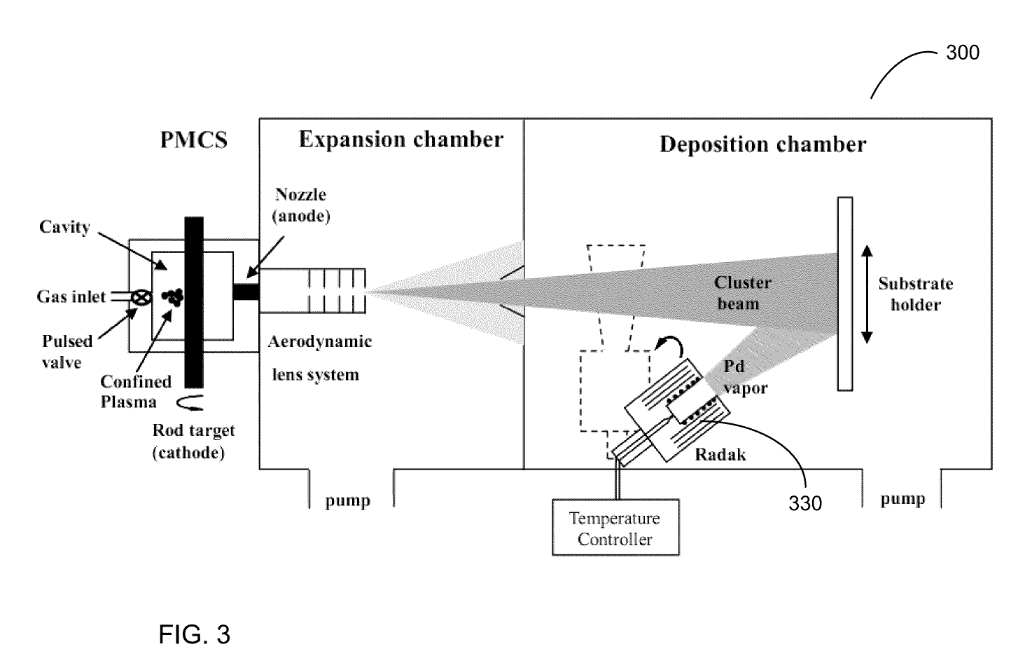

Supersonic Cluster Beam Deposition (SCBD) technique can be utilized to fabricate the present hydrogen gas sensor. As shown in FIG. 3, the SCBD system 300 consists of a pulsed micro-plasma cluster source (PMCS), a supersonic expansion chamber and a deposition chamber. A metal rod is mounted in the PMCS chamber and driven to rotate with a motor. Argon gas (Ar) pulses are admitted into the chamber at a certain frequency. Meanwhile, negative voltage pulses are applied to the metal rod with the same rate, and are controlled to have a time delay relative to the gas pulses. Discharges are induced to sputter atoms from the target. The sputtered atoms aggregate in the discharge chamber to form nanoclusters of several nanometers in size. The nanoclusters are carried by the Ar flow to enter an expansion chamber, where the gas flow experiences a supersonic expansion. Meanwhile, the nanoclusters pass through a set of aerodynamic lens. Only the nanoclusters of sizes lying in a narrow range can pass and form a collimated particle beam. Finally, they enter a deposition chamber and land on a substrate (a mechanical support) to form deposits of nanoclusters sensor. The kinetic energies of the nanoclusters are low, such that they are not deformed during landing, but retain the cluster shape. Thereby, the structure of the deposits contains many pores. A post-annealing process is performed to stabilize the structure and to ensure that most metal atoms are fully oxidized.

After a layer of nanoclusters is created, a catalytic coating (Pd or Pt) is deposited on the surface of the outer layer of nanoclusters. With this approach, the H₂ sensing response is mainly due to the resistive change of the outermost layer of nanoclusters. In addition, the thickness of a catalytic coating should be carefully controlled to fall in a narrow range, otherwise, a thinner one is unable to provide strong enough catalytic effect, while a thicker one would cause excessive lowering of the base resistance due to surface “short-circuit” effect and suppresses the sensitivity of detection. According to one embodiment, the thickness of the catalytic coating is controlled to fall between 0.1 to 20 nm. If the catalytic material is delicately controlled to distribute throughout the depth, more nanoclusters can contribute to generate resistive response and help to enhance sensitivity of detection. The base resistance of the film can be better adjusted rather than relying on the thickness of a single surface catalytic layer needed to be confined in a very narrow range.

The catalytic coating is deposited on the metal oxide nanoclusters using a physical vapor deposition (PVD) method or thermal deposition in accordance with one embodiment of the present invention. A PVD process is characteristic of relying on a more repeatable physical process to ensure the repeatability of the coating's properties.

Referring to FIG. 3, an evaporator 330 or equivalent, such as RADAK vacuum furnace, is incorporated in the deposition chamber of an SCBD system 300. Thus, catalytic material can be simultaneously evaporated in an SCBD process and deposited on each individual nanoclusters to realize the structure illustrated in FIG. 2(a). The evaporator is capable of providing stable and controllable evaporation rate. It can be orientated for the catalytic to reach the nanoclusters when they are travelling towards the substrate (i.e., a condensed material) in the vacuum, or when they have just landed on the substrate holder. With this approach, the catalytic coating has a depth profile to make most nanoclusters to engage in generating resistive response for maximizing the sensitivity of H₂ detection. The total amount of the metal is better controlled, such that the base resistance can be finely tuned. Another advantage is to avoid instability of the output as in the case where only a single catalytic layer is added, which would undergo plastic deformation due to reciprocating volume changes caused in hydrogenation-dehydrogenation cycles.

In addition, a low-power heater, such as a tiny thin-film heater can be either added on the top surface of the catalyzed nanocluster-based sensor or pre-deposited on the substrate. It serves to rise Tₛₑₙₛₒᵣ slightly to optimize the performance of the sensor, in particular for achieving a higher sensitivity and a shorten t_{R}. Furthermore, as verified in one worked example using tungsten oxide (WO₃) for H₂ detection, the influence of RH on the output can be greatly suppressed by setting Tₛₑₙₛₒᵣ at 80° C.

Furthermore, UV light of photon energy above the bandgap can be used to illuminate the MOₓ nanoclusters for generating electron-hole pairs. For example, UV light with photon energy larger than the bandgap of the oxide (e.g. UV light of wavelength=370 nm for zinc oxide), say from a properly selected LED, can be used to shine on the sensor. By using UV light, some of the holes can migrate to reach the oxide surface to recombine with the trapped electrons. This process assists the reaction between the surface sorbed oxygen and H₂ from the monitored environment, and accelerates detachment of the oxygen molecules. With the change of the thickness of the depletion layer, the sensor shows a resistive change. This photo-assist effect can replace the need of an elevated Tₛₑₙₛₒᵣ required by a conventional MOₓ-based H₂ sensor for maintaining dense enough hole concentration for achieving a reasonable fast response rate. However, the photo-assisted effect may also be used in conjunction with elevated temperature of the sensor.

PVD method is employed to fabricate the gas sensing nanoclusters because it relies on a physical process controlled by a set of physical parameters, which are more repeatable to ensure satisfactory batch-to-batch reproducibility of products compared with the pick-and-drop method frequently used in handling nano-sized materials.

Microfabrication techniques can be used in producing H₂ sensors for miniaturizing the sensor products. A sensor of a smaller size usually consumes less power and has a lower production cost.

In another embodiment, a H₂-permeable filter, such as a molecular sieve, made of a properly selected material can be added to the sensor to block gaseous interferants for improving the selectivity, as well as suppressing the influence from moisture, oil mist and dust, etc. In lieu of a H₂-permeable filter, more than one filters for specific gas species may also be utilized.

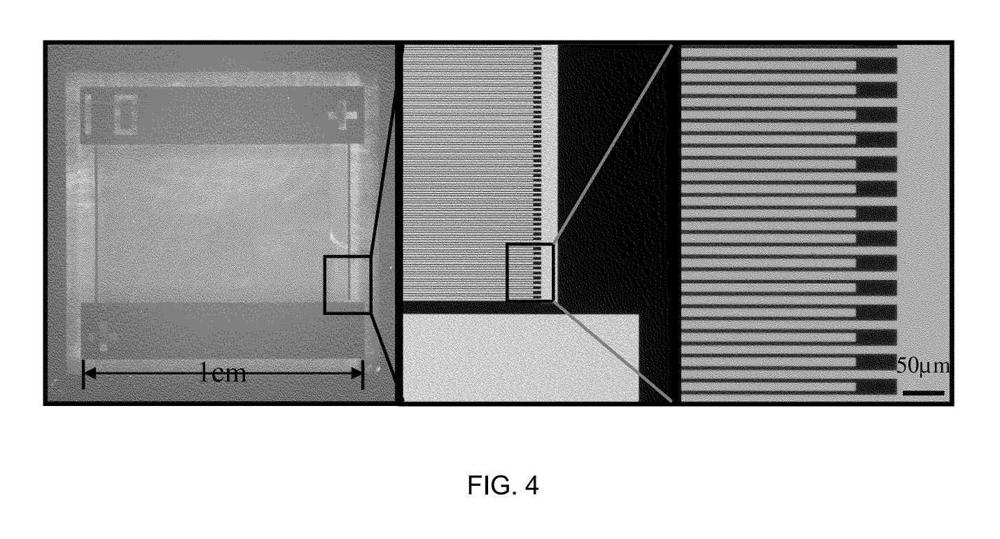

Interdigital electrodes (IDEs) with a pattern like that illustrated in FIG. 4, could be made on a highly resistive oxide-based nanoclusters sensor for adjusting the base resistance to fall in a reasonable level. The reduction factor is N×(l/b), where N is the number of finger pairs, l the length of sensor, and b the gap size between two adjacent fingers. Thus, l/b=length of a film resistor/gap size between two adjacent fingers in an IDE pattern. For example, if N=1000, l=1 cm and b=5 μm, the reduction factor is as high as 2×10⁸ times.

### EXAMPLE 1

### Pd/SCBD WO₃ Hydrogen Sensor

In this example, Pd coated WO₃ nanoclusters produced by using SCBD technique was fabricated and found to have H₂ sensing properties superior to most existing H₂ sensor products and research prototypes in many aspects.

A tungsten rod of 2 mm in diameter and purity of 99.95% was used as the target in an SCBD process to generate tungsten-oxide nanoclusters. Ar gas pulses were admitted with a frequency of 4 Hz. Electrical pulses of −800 V were applied to the target at the same frequency, with a delay of 220 μs relative to the gas pulses. The deposits were post-annealed at 250° C. in air for 12 hr. A 5 nm Pd catalytic coating was finally sputtered on its surface.

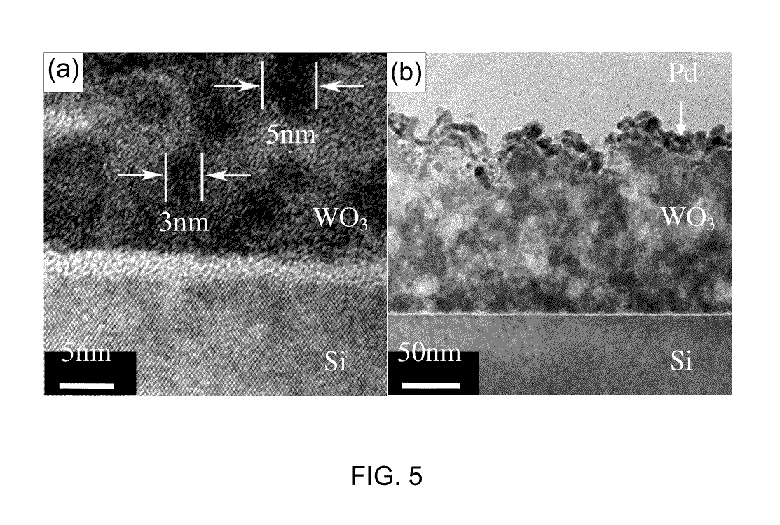

The targeted features of the structure are achieved. Transmission electron microscopic (TEM) image of the sensor, FIG. 5(a), shows that the sensor contains WO₃ nanoclusters with an average characteristic length of about 3 to 5 nm. The mass-equivalent thickness of a film of metal tungsten nanoclusters measured by using a quartz monitor during deposition is 14.1 nm, but the actual thickness of the WO₃ nanoclusters derived from an TEM image is 140 nm, such that the porosity of the structure is estimated to be 66%.

FIG. 5(b) is a TEM image showing that a Pd coating with a thickness of ˜5 nm is deposited on the surfaces of the outermost layer of nanoclusters.

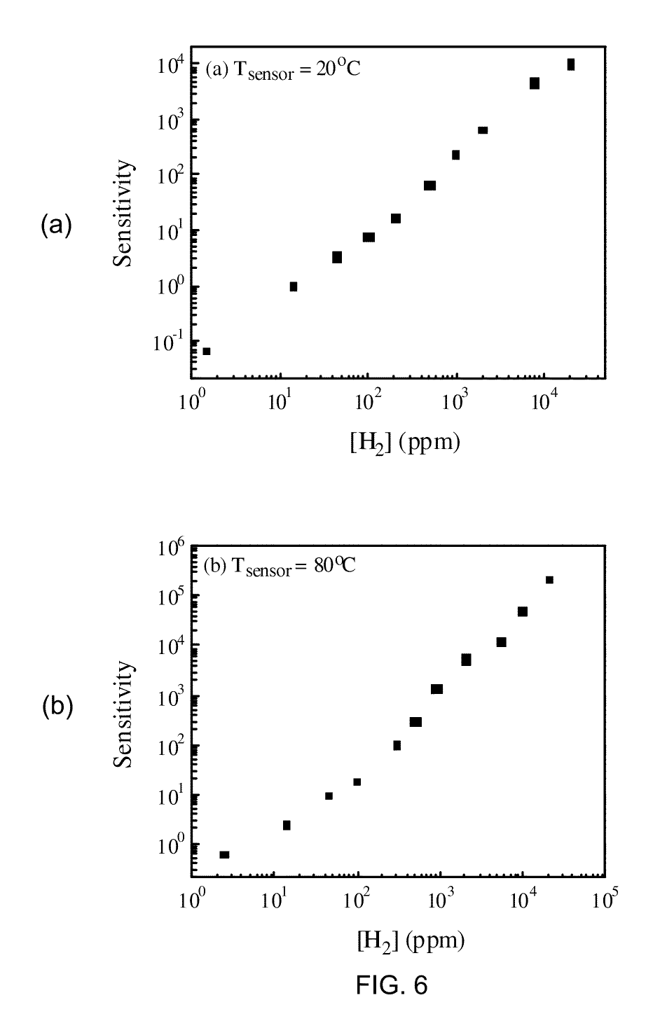

FIGS. 6(a) and (b) show the measured sensitivity of the sensor at 20 and 80° C., respectively. It increases monotonically with [H₂]. The true LDL is generally lower than the lowest [H₂] employed in the measurement, and is needed to be estimated. One starts from determining the noise level, which is set to be the fluctuation of the fractional change of the base resistance. As discussed in Currie's paper, “Nomenclature in Evaluation of Analytical Methods Including Detection and Quantification Capabilities”, if a resistive change over three times of this level is recognized to be a true signal, the minimum detectable sensitivity Sₘᵢₙ is set to be 3 times of the noise level divided by the base resistance. The experimental relationship of S˜[H₂] is now extrapolated to find the value of [H₂] corresponding to Sₘᵢₙ, which is used to represent the true LDL. With these procedures, the true LDLs of the sensor at Tₛₑₙₛₒᵣ=20 and 80° C. are estimated to be 0.037 and 0.028 ppm, which are higher than the existing H₂ sensor products (Table I).

NS of the sensor measured at Tₛₑₙₛₒᵣ=20 and 80° C. for 2% H₂-air are 0.527 and 9.4 (Table I). They are higher than those of all existing H₂ sensor products and many nano material-based H₂ sensor prototypes.

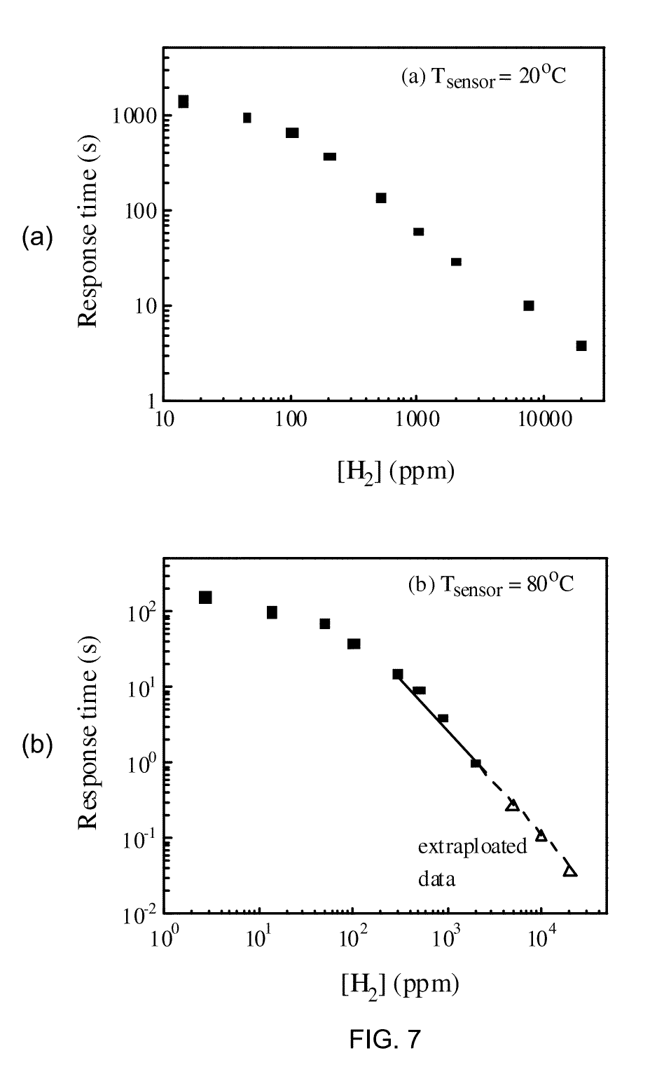

FIGS. 7(a) and (b) show that t_{R} of a Pd/SCBD WO₃ sensor measured at Tₛₑₙₛₒᵣ=20 and 80° C. drops with increasing [H₂], and reaches 4 s and below 1 s respectively at [H₂]=2% in air (Table I). The response times are faster than most existing H₂ sensor products and nano material-based H₂ sensor prototypes. The trend of the plots indicates that t_{R} of the sensor may even drop further if [H₂] continues to increase.

It is confirmed that the H₂ sensing response of a Pd/SCBD WO₃ sensor can repeat very well over a period of two years, and hence the lifetime of the sensor is claimed to be two years at least, comparable with those of many H₂ sensor products (Table I).

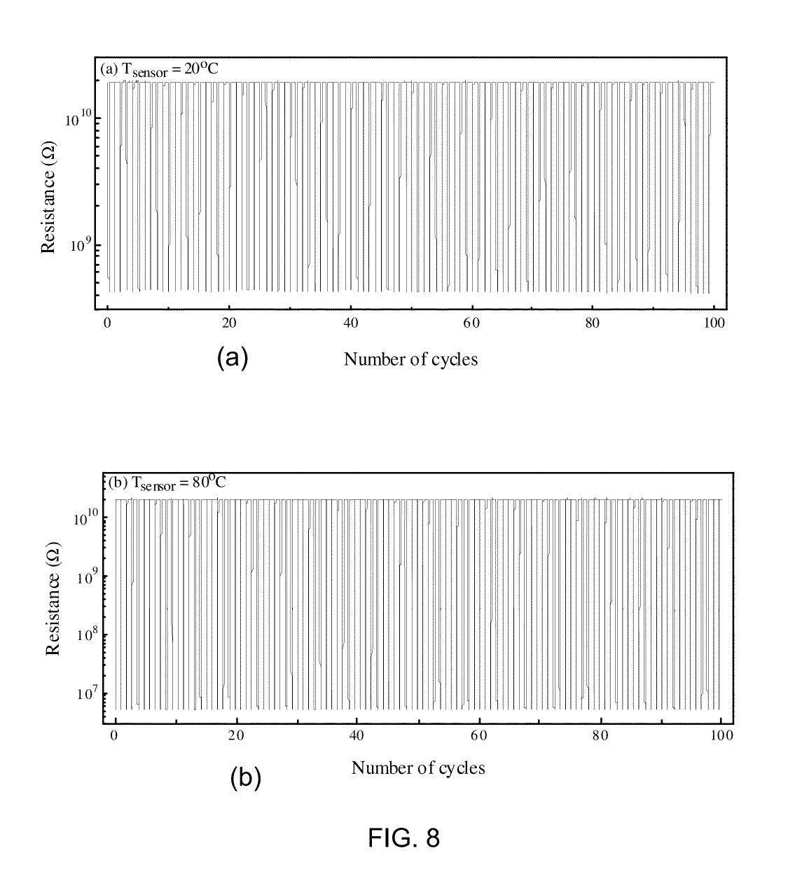

FIGS. 8(a) and (b) show the resistive response of a Pd/SCBD WO₃ sensor measured in cyclic mode at Tₛₑₙₛₒᵣ=20° C. and 80° C. respectively. The nanoclusters sensor is shunted with a 20-GΩ resistor. Hydrogenation and dehydrogenation were performed by repeatedly exposing the sensor to 2% H₂-air admixture and air alternatively. The resistance of the assembly was found to oscillate steadily between 20 GΩ and 400MΩ at Tₛₑₙₛₒᵣ=20° C., and between 20 GΩ and 5MΩ at Tₛₑₙₛₒᵣ=80° C., respectively. The outputs were highly repeatable over 100 cycles, confirming that the cyclic stability of a Pd/SCBD WO₃ hydrogen sensor is excellent. Similar data of other H₂ sensors are not readily available for comparison.

The output of a Pd/SCBD WO₃ sensor was insensitive to many VOCs, including methanol, ethanol, iso-propanol, formaldehyde and acetone. Its selectivity is claimed to be superior to that of an EC-type sensor, a conventional MOₓ-type sensor and a CC-type sensor (Table I).

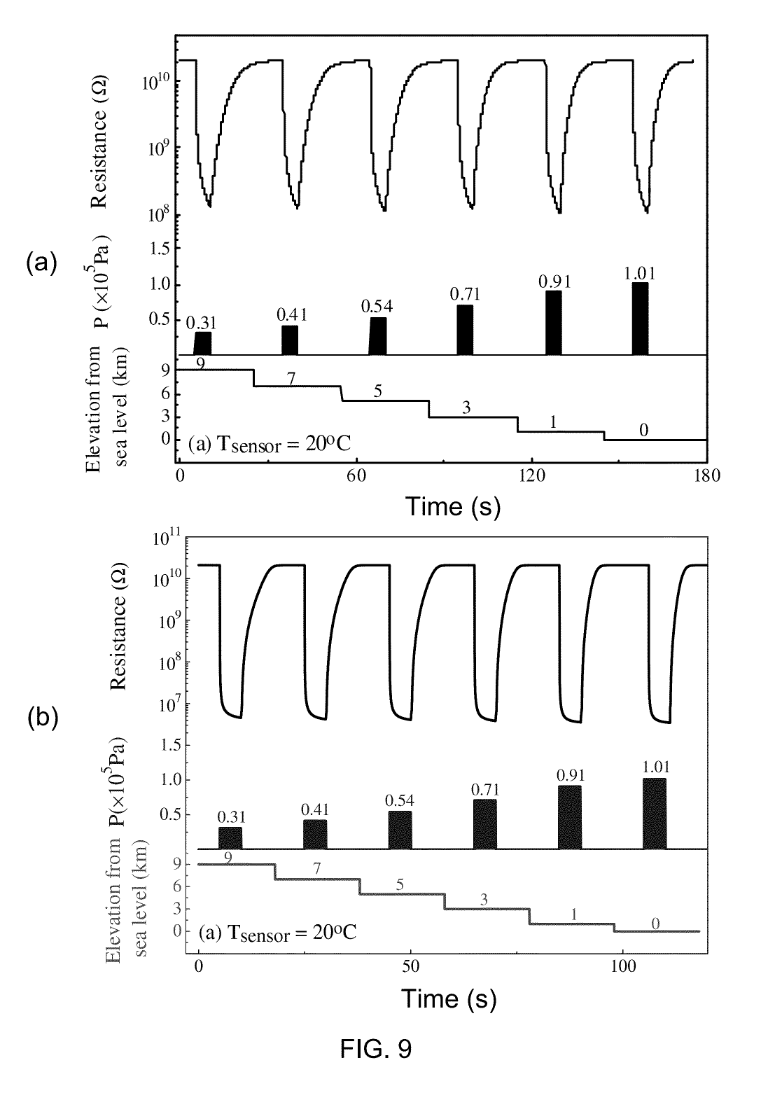

FIGS. 9(a) and (b) show that the output of the sensor is practically independent on atmospheric pressure from 101 to 30.7 kPa. The gas admixture used in the tests was 2% H₂ in air. Elevations associated with the changes are marked in the figure. This pressure change can be associated with an elevation from sea level to 9000 m, covering the usual operation scope of a vehicle, suggesting that a Pd/SCBD WO₃ sensor is suitable to be used in a H₂-driven vehicle for monitoring H₂ leakage in the compartment. The stability of the output of the present sensor against the change in ambient pressure is superior to that of EC-type, conventional MOₓ-type or CC-type H₂ sensors (Table I).

The sensor can be operated at a lower Tₛₑₙₛₒᵣ. This low temperature feature leads to many advantages. However, it is still suggested to be operated at a moderate Tₛₑₙₛₒᵣ around 80° C., where a lower LDL, broader dynamic range, higher sensitivity, shorter t_{R}, higher stability, higher selectivity, lower power consumption, and less RH dependence of the output are achieved.

### EXAMPLE 2

### Palladium Catalyzed SCBD Zinc Oxide (ZnO) Hydrogen Gas Sensor

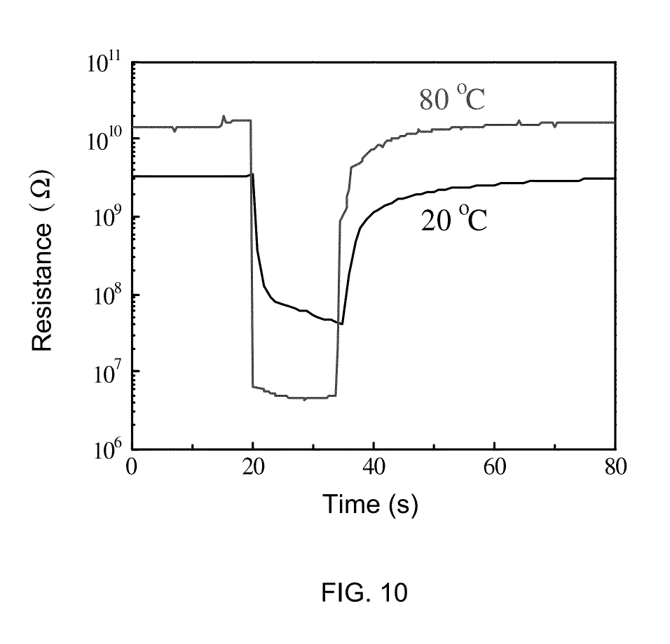

In this example, ZnO nanoclusters film was produced by SCBD technique and was annealed at 550° C. for 1 hour. Thereafter, a 5 nm Pd layer was sputtered onto the surface of SCBD ZnO nanoclusters film. FIG. 10 shows the resistance change of Pd/SCBD ZnO sensor when exposed to 2% H₂-air mixture, at 20 and 80° C. At 20° C., the sensitivity and response time are 80.28 and 1 s, respectively. To our knowledge, this response rate is the fastest among those of all other MOₓ-based hydrogen sensors operating at room temperature. At 80° C., the sensitivity and response time are further improved to be 3242 and <0.3 s, respectively.

While the exemplary embodiments describe above illustrate sensors for hydrogen gas sensing, the present sensor structures of FIGS. 1(a)-(c) and FIGS. 2(a)-(c) can be used to detect other types of gases. For instance, oxygen and formaldehyde gas sensors are described below in connection with example 3 and example 4.

### EXAMPLE 3

### SCBD ZnO Oxygen Gas Sensor

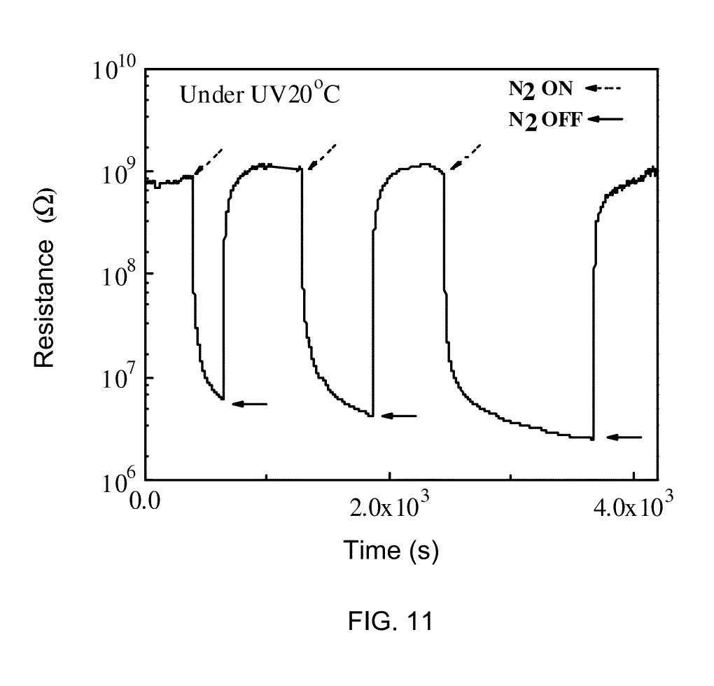

In this example, ZnO nanoclusters film was produced using SCBD technique and was annealed at 550° C. for 2 hours. FIG. 11 shows the resistance change of SCBD ZnO oxygen sensor when exposed to air and nitrogen repeatedly at 20° C. under UV irradiation. It is shown in the figure that, when the ambient gas switched from oxygen to nitrogen, the resistance of the sensor decreased significantly and immediately. The maximum sensitivity and response time of the sensor are 400 and 10 s, respectively.

### EXAMPLE 4

### SCBD Titanium Oxide (TiO₂) Formaldehyde Gas Sensor

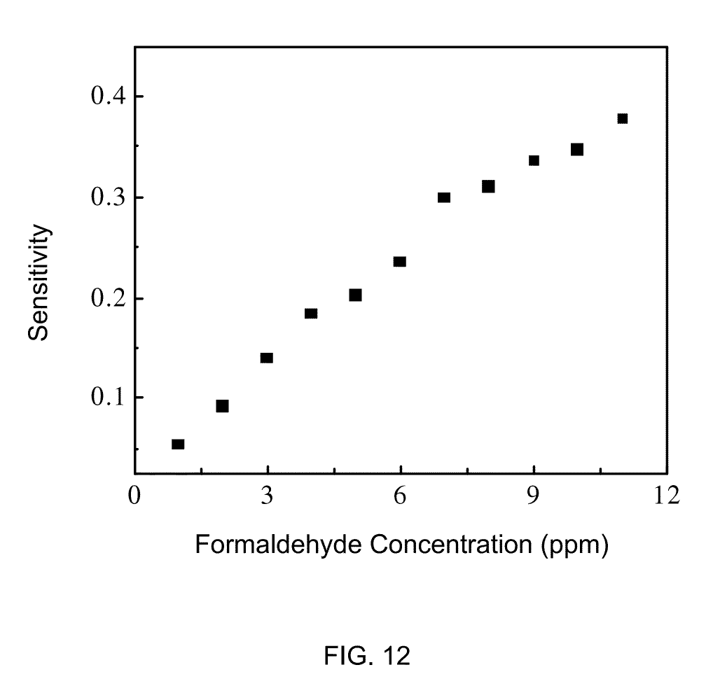

In this example, TiO₂ nanoclusters film was fabricated by using SCBD technique and was annealed at 500° C. for 2 hours. FIG. 12 shows the sensing properties of SCBD TiO₂ thin film to formaldehyde varied from 1 to 11 ppm in air at room temperature (20° C.) with UV irradiation. It can be seen from FIG. 12 that the sensitivity of TiO₂ nanoclusters film to formaldehyde increases almost linearly with increasing formaldehyde concentration. The slope is about 0.03 per ppm, which is about 30% higher than the existing values of nanowires-type or nanotubes-type formaldehyde sensors. Moreover, SCBD TiO₂ formaldehyde sensor can operate at 20° C., which is much lower than the operation temperature (250° C.) of conventional sensors.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

What is claimed is:

1. A gas sensor comprising:
a plurality of loosely connected metal oxide nanoclusters configured to provide a porous structure, the metal oxide nanoclusters having an average characteristic length of 1 nm to 20 nm; and
a coating made with catalytic material is deposited on an outer layer of the metal oxide nanoclusters.

2. The gas sensor of claim 1, wherein the metal oxide nanoclusters is capable of changing at least one of its properties when reacting with gaseous substances.

3. The gas sensor of claim 1, wherein the nanoclusters are loosely connected by physical contact or necking in between, with porosity of at least 20%.

4. The gas sensor of claim 1, wherein the coating is capable of facilitating hydrogen, oxygen, or formaldehyde detection.

5. The gas sensor of claim 1, wherein the coating is deposited on each of the metal oxide nanoclusters.

6. The gas sensor of claim 1, wherein the coating is deposited on the metal oxide nanoclusters by using a physical vapor deposition method or a thermal deposition method.

7. The gas sensor of claim 1, wherein the nanoclusters are formed by Supersonic Cluster Beam Deposition method.

8. The gas sensor of claim 1, wherein the metal oxide nanoclusters have a resistance when they are in the background environment, and the resistance of the metal oxide nanoclusters varies with a concentration of specific gaseous species.

9. The gas sensor of claim 1, further comprising a heating element configured to heat up the metal oxide nanoclusters between 20 to 200° C.

10. The gas sensor of claim 1, wherein the metal oxide nanoclusters are illuminated with ultraviolet light with photon energy above the bandgap of the metal oxide.

11. The gas sensor of claim 1, further comprises one or more filters for specific gas species.

12. The gas sensor of claim 1, wherein the gas sensor is applied on interdigital electrodes to facilitate measurements.

13. The gas sensor of claim 1, wherein the catalytic material is palladium, platinum, silver, gold, rhodium, ruthenium, nickel, iron, cobalt, osmium, their alloys and oxides, or a combination thereof.

14. The gas sensor of claim 1, wherein the metal oxide is tungsten oxide, tin oxide, titanium oxide, zinc oxide, iron oxide, niobium oxide, vanadium oxide, molybdenum oxide, compounds formed by said metal oxides, or a combination thereof.

15. The gas sensor of claim 1, wherein the metal oxide nanoclusters is formed on a condensed material.
